(19) United States
(12) Patent Application Publication
(10) Pub. No.: US 2006/0100742 A1
(43) Pub. Date: May 11, 2006

(54) Device for tracing movement of mobile robot and method thereof

(75) Inventor: Jin-Seok Park, Gwangmyeong (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/108,652

(22) Filed: Apr. 19, 2005

(30) Foreign Application Priority Data
Nov. 10, 2004 (KR) 91596/2004

(51) Int. Cl. G05B 15/00

(52) U.S. Cl. 700/259

(57) ABSTRACT

Disclosed are a device for tracing a movement of a mobile robot and a method thereof. The device for tracing a movement of a mobile robot includes: a camera for capturing a specific object; a movement tracing and image generating unit for setting a reference area in the present image produced by capturing the specific object by the camera and generating the present image in which the reference area is set; a difference image extracting unit for extracting a difference image of pixels of the edge of the reference area of the present image and pixels of the reference area of a previous image; and a microcomputer for tracing a movement of the specific object based on the extracted difference image.

### BACKGROUND OF THE INVENTION

1. Field of the Invention

The present invention relates to a mobile robot such as a robot cleaner, and more particularly, to a device for tracing a movement of a mobile robot and a method thereof.

2. Description of the Background Art

In general, a robot cleaner, one kind of a mobile robot, is a device for automatically cleaning a cleaning area by sucking debris such as dust from a floor while driving by itself within the area to be cleaned without user's manipulation.

Such a robot cleaner is designed to perform the cleaning operation while driving a preset cleaning path according to an embedded program. In order that the robot cleaner automatically travels along the preset cleaning path and performs the cleaning operation, a large number of sensors are used to detect a location and a traveling distance of the robot cleaner, and an obstacle around the robot cleaner.

However, in order for such a robot cleaner to perform the cleaning operation while driving the preset cleaning path, many expensive sensors are installed at the robot cleaner, thereby complicating its internal structure and increasing fabrication cost.

In order to solve such a problem, a robot cleaner has been developed to perform the cleaning operation in a random manner while traveling along an arbitrary cleaning path.

FIG. 1 is a block diagram illustrating a construction of a traveling device of a robot cleaner in accordance with the conventional art.

As shown in FIG. 1, a traveling device of the conventional robot cleaner includes: an obstacle sensing unit 1 for sensing an obstacle according to a collision occurring when the robot cleaner goes straight in a specific area; a control unit 2 for stopping the traveling of the robot cleaner based on a signal outputted from the obstacle sensing unit 1, generating a random angle randomly and rotating the robot cleaner by the random angle, which is used as the angle of rotation; a left wheel motor driving unit 3 for driving a left wheel motor 5 of the robot cleaner at a certain speed according to a control signal generated from the control unit 2; and a right wheel motor driving unit 4 for driving a right wheel motor 6 of the robot cleaner at a certain speed according to a control signal generated from the control unit 2.

Hereinafter, an operation of the conventional robot cleaner having such a construction will be described with reference to FIG. 2.

FIG. 2 is a flowchart illustrating an operation with respect to a traveling method of a robot cleaner in accordance with the conventional art.

As shown in FIG. 2, a traveling method of the conventional robot cleaner comprises: a user inputs a cleaning command and allows the robot cleaner to go straight to thereby sense an obstacle (S1 to S3); the robot cleaner is stopped if the obstacle is sensed according to the sensing result and then an arbitrary random angle is generated in a random manner (S4); the generated random angle is used as an angle of rotation and the robot cleaner is rotated according to the angle of rotation(S5); the rotated robot cleaner goes straight (S6); and the traveling of the robot cleaner is stopped when the cleaning operation of the robot cleaner is completed by determining whether or not the robot cleaner has completed the cleaning operation while going straight (S7).

The traveling method of the conventional robot cleaner will be described in detail.

First, when the user inputs a cleaning command of the robot cleaner (S1), the control unit 2 outputs a control signal to make the driving speed of the left wheel motor 5 equal with that of the right wheel motor 6 such that the robot cleaner can go straight.

The left motor driving unit 3 drives the left wheel motor 5 according to the outputted control signal and the right motor driving unit 4 drives the right wheel motor 6 according to the outputted control signal. Accordingly, the robot cleaner goes straight by the driven left and right wheel motors 5 and 6 (S2).

When the robot cleaner collides with an arbitrary obstacle while going straight, the obstacle sensing unit 1 senses the obstacle based on an impact amount generated by the collision and supplies the control unit 2 with an obstacle sensing signal according to the sensing (S3).

Then, the control unit 2 stops the traveling of the robot cleaner according to the supplied obstacle sensing signal, generates an arbitrary random angle in a random manner (S4), and outputs a control signal to make the generated random angle the angle of rotation of the robot cleaner. At this time, the control unit 2 outputs control signals to make the speed of the left wheel motor 5 different from that of the right wheel motor 6 to the left wheel motor driving unit 3 and the right wheel motor driving unit 4 such that the robot cleaner can rotate by the angle of rotation.

Accordingly, the left wheel motor driving unit 3 drives the left wheel motor 5 according to the control signal outputted from the control unit 2, and the right wheel motor driving unit 4 drives the right wheel motor 6 according to the control signal outputted from the control unit 2, so that the robot cleaner is rotated by the arbitrary random angle (S5).

Next, the control unit 2 allows the robot cleaner to go straight by outputting a control signal to make the speed of the left wheel motor 5 equal with that of the right wheel motor 6 to the left wheel motor driving unit 3 and the right wheel driving unit 4 (S6).

While the robot cleaner goes straight, it is determined whether or not the robot cleaner has completed the cleaning operation. When the robot cleaner completes the cleaning, the cleaning operation of the robot cleaner is completed by stopping the traveling of the robot cleaner. When the robot cleaner does not complete the cleaning yet, the cleaning operation is repetitively performed by returning to the step of sensing an obstacle.

The above-described robot cleaner including a multimedia function as well as a cleaning function has lately been developed.

That is, the robot cleaner has been developed such that by using the robot cleaner, multiple contents can be downloaded by connecting to an external Internet network or a wireless mobile communication network and then reproduced or applied.

In addition, the robot cleaner is used to trace a change or a movement of the surroundings of the robot cleaner by using a camera of the robot cleaner.

In a technique for tracing a change or a movement of the surroundings of the robot cleaner by using the camera embedded in a mobile robot such as the conventional robot cleaner, the present image and the future image produced by capturing a specific object by the camera embedded in the mobile robot are extracted and then a movement of the specific object is traced by obtaining a difference image of the extracted two images. At this time, a portion where the specific object greatly moves shows a high value of the difference image, so that the portion where the specific object greatly moves looks white.

However, the technique for tracing a movement of a specific object of the conventional mobile robot takes long operation time because it should perform a one-to-one comparison between all the pixels of the extracted present image and all the pixels of the extracted future image.

### SUMMARY OF THE INVENTION

Therefore, an object of the present invention is to provide a device for tracing a movement of a mobile robot and a method thereof capable of not only significantly reducing the amount of operation of comparing pixels in order to trace a movement of a specific object but also efficiently sensing the movement of the specific object in all direction by tracing the movement of the specific object on the basis of a difference image of pixels corresponding to the edge of a preset reference area among all the pixels of the present image produced by capturing the specific object and among all the pixels of the previous image of the specific object which was captured a certain time ago.

To achieve these and other advantages and in accordance with the purpose of the present invention, as embodied and broadly described herein, there is provided a device for tracing a movement of a mobile robot, comprising: a camera for capturing a specific object; a movement tracing and image generating unit for setting a reference area in the present image produced by capturing the specific object by the camera and generating the present image in which the reference area is set; a difference image extracting unit for extracting a difference image of pixels of the edge of the reference area of the present image and pixels of the reference area of a previous image; and a microcomputer for tracing a movement of the specific object based on the extracted difference image.

To achieve these and other advantages and in accordance with the purpose of the present invention, as embodied and broadly described herein, there is provided a method for tracing a movement of a mobile robot, comprising: capturing a specific object; setting a reference area in the present image produced by capturing the specific object and generating the present image in which the reference area is set; extracting a difference image of pixels of the edge of the reference area of the generated present image and pixels of the edge of the reference area of a previous image which was captured a certain time ago; and tracing a movement of the specific object based on the extracted difference image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a construction of a traveling device of a robot cleaner in accordance with the conventional art;

FIG. 2 is a flowchart illustrating an operation with respect to a traveling method of a robot cleaner in accordance with the conventional art;

FIG. 3 is a block diagram illustrating a construction of a device for tracing a movement of a mobile robot in accordance with the present invention; and

FIG. 4 is a flowchart illustrating an operation with respect to a method for tracing a movement of the mobile robot in accordance with the present invention.

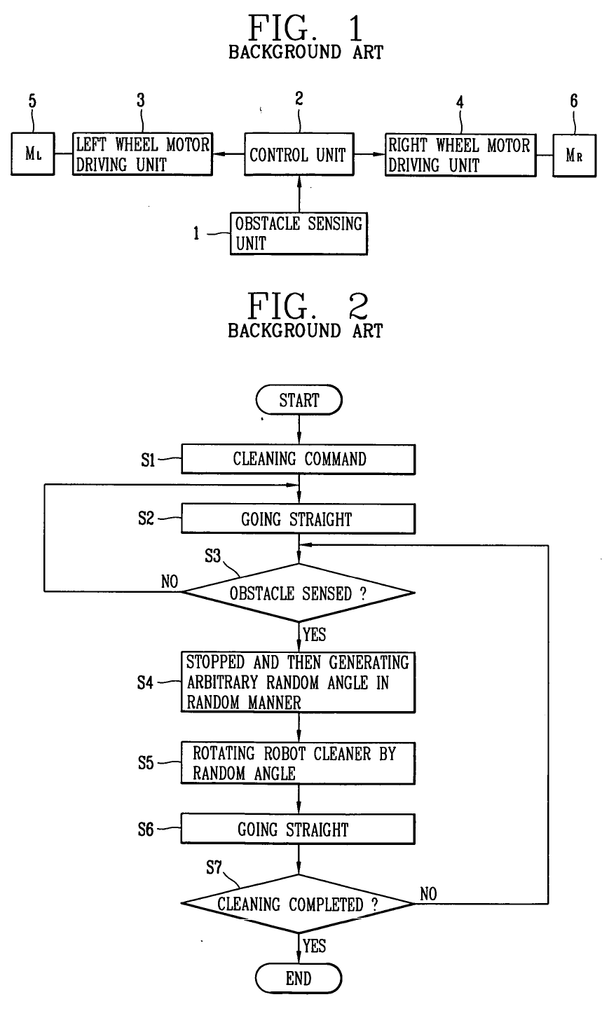

### DETAILED DESCRIPTION OF THE PREFERRED EMBODIMENTS

Reference will now be made in detail to the preferred embodiments of the present invention, examples of which are illustrated in the accompanying drawings.

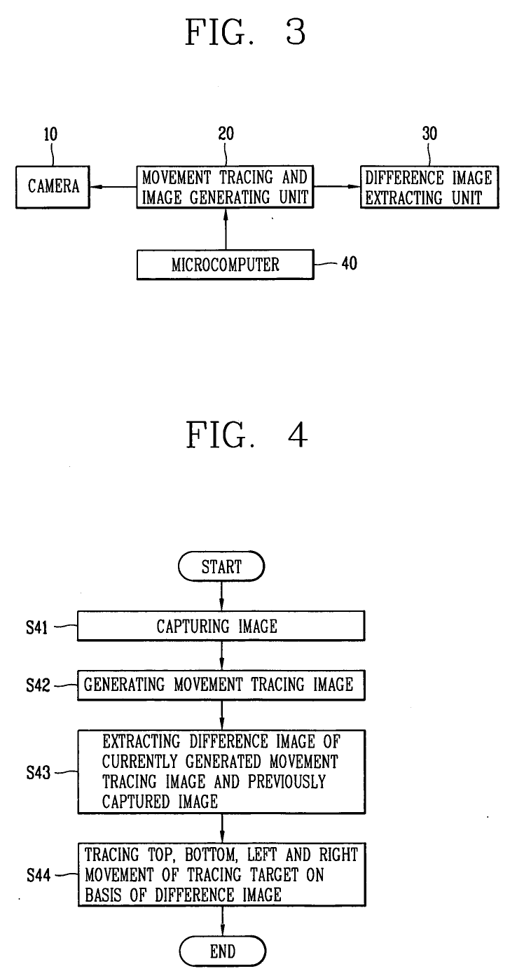

Hereinafter, the preferred embodiments of a device for tracing a movement of a mobile robot and a method thereof capable of not only significantly reducing the amount of operation of comparing pixels so as to trace a movement of a specific object and but also efficiently sensing a movement of the specific object in every direction by tracing the movement of the specific object on the basis of a difference image of pixels corresponding to the edge of a preset reference area among all pixels of the present image produced by capturing the specific object and among all pixels of a previous image of the specific object which was captured a certain time ago will be described in detail with reference to FIGS. 3 and 4.

FIG. 3 is a block diagram illustrating a construction of a device for tracing a movement of a mobile robot in accordance with the present invention.

As shown in FIG. 3, the device for tracing a movement of a mobile robot in accordance with the present invention includes: a camera 10 for capturing a specific object; a movement tracing and image generating unit 20 for setting a reference area in the present image produced by capturing the specific object by the camera and generating the present image in which the reference area is set; a difference image extracting unit 30 for extracting a difference image of pixels corresponding to the edge of the reference area of the present image and pixels corresponding to the edge of the reference area of a previous image; and a microcomputer 40 for tracing a movement of the specific object on the basis of the extracted difference image.

Hereinafter, an operation of the device for tracing a movement of the mobile robot in accordance with the present invention will be described in detail.

FIG. 4 is a flowchart illustrating an operation with respect to a method for tracing a movement of the mobile robot in accordance with the present invention.

As shown in FIG. 4, a method for tracing a movement of the mobile robot in accordance with the present invention comprises: capturing a specific object (S41); setting a reference area in the present image produced by capturing the specific object and generating the present image in which the reference area is set (S42); extracting a difference image of pixels corresponding to the edge of the reference area of the generated present image and pixels corresponding to the edge of the reference area of a previous image which was captured a certain time ago (S43); and tracing a movement of the specific object on the basis of the extracted difference image.

The method for tracing a movement of the mobile robot in accordance with the present invention will be described in detail as follows.

First, when the user selects a mode for tracing a movement of the mobile robot, the mobile robot captures a moving specific object to produce an image by using the camera 10 (S41). The captured image of the specific object is outputted to the movement tracing and image generating unit 20.

The movement tracing and image generating unit 20 sets the reference area in the inputted image of the specific object in order to trace a movement of the specific object (S42). Then, the movement tracing and image generating unit 20 outputs an image in which the reference area is set to the difference image extracting unit 30. Here, the reference area is previously set by the user, can be formed by a polygon and has a variable size. Herein, the reference area is a square, preferably.

The difference image extracting unit 30 compares pixels corresponding to the edge of the reference area of the present image, in which the reference area is set, currently outputted from the movement tracing and image generating unit 20 with pixels corresponding to the edge of the reference area of the previous image which was captured a certain time ago, and then extracts a difference image on the basis of a value of the comparison result (S43). The difference image extracting unit 30 outputs the extracted difference image to the microcomputer 40. Here, the difference image extracting unit 30 may store information on pixels only corresponding to the reference area among all pixels of the previous image or store information on all pixels of the previous image. However, it is desirable to store information on the pixels corresponding to the reference area among all the pixels of the previous image. Here, since the extracting of a difference image between two images belongs to the conventional art, a description for a method for extracting a difference image will be omitted here.

The microcomputer 40 traces a movement of the specific object (e.g., left, right, top and bottom) on the basis of the inputted difference image. In case the reference area is a square, the movement of the specific object is traced on the basis of a difference between pixels only existing at a top, bottom, right or left edge (S44).

In case that the reference area is a square in the embodiment, the microcomputer 40 checks only a difference (difference image) between pixels corresponding to the four sides of the square of the present image and pixels corresponding to the four sides of the square of the previous image. Here, if there is a difference between pixels, a portion showing the difference looks white in the difference image.

More detailed description will be followed by taking examples.

In case the reference area is set by a square which is ‘150’ by ‘100’ in size, the device for tracing a movement of a mobile robot in accordance with the conventional art requires an operation process of comparing 150×100=15000 pixels of the present image and the previous image in order to trace the specific object. On the other hand, the device for tracing a movement of the mobile robot in accordance with the present invention requires an operation of comparing only 500 pixels, which is the sum obtained by adding up the lengths of the top, bottom, right and left sides. In addition, when the specific object moves within the square and goes across neither of the four sides of the square, no difference exists between the pixels corresponding to the four sides of the square of the present image and the pixels corresponding to the four sides of the square of the previous image. Accordingly, a portion looking white does not exist in the difference image. Therefore, the microcomputer 40 ignores (cannot sense) a movement of the specific object and does not move the camera 10. On the other hand, when the specific object goes across the right side of the square and moves, a difference exists in pixels corresponding to the right side of the four sides of the square between the present image and the previous image, whereby a difference image exists. Therefore, the microcomputer 40 senses that the specific object has moved to the right and moves the camera 10 to the right. When the specific object goes across the top side of the square and moves, a difference exists in the pixels corresponding to the top side of the four sides of the square, whereby a difference image exists. Therefore, the microcomputer 40 senses that the specific object has moved upward and moves the camera 10 upward.

In a same manner, when the specific object goes across the left side of the square and moves, the microcomputer 40 moves the camera 10 to the left. When the specific object goes across the bottom side of the square and moves, the microcomputer 40 moves the camera 10 downward. Here, the user can vary a size of the square.

Another embodiment of the method for tracing a movement of the mobile robot in accordance with the present invention will be described as follows.

Another embodiment of the method for tracing a movement of the mobile robot in accordance with the present invention comprises: capturing a specific object; comparing pixels corresponding to the edge of a preset reference area among pixels of the present image of the specific object currently being captured with pixels corresponding to the edge of the reference area among pixels of the previous image of the specific object which was captured a certain time ago; and tracing a movement of the specific object on the basis of the comparison result. Here, the step of comparing the pixels further comprises a step of extracting a difference image only of an image corresponding to the reference area of the present image and an image corresponding to the reference area of the previous image.

Here, the method for extracting a difference image and an operation of the camera of the mobile robot on the basis of the extracted difference image are the same as described so far.

In the present invention, a movement of the specific object is traced by sensing a difference only of pixels corresponding to the edge of a reference area among all the pixels of the present image and of the previous image after setting the reference area of a certain standard in the image produced by capturing the specific object.

As described in detail so far, the device for tracing a movement of the mobile robot in accordance with the present invention and the method thereof can significantly reduce the amount of operation of comparing pixels in order to trace a movement of the specific object and efficiently sense the movement of the specific object in all direction by tracing the movement of the specific object on the basis of a difference image of pixels corresponding to the edge of a preset reference area among all the pixels of the present image produced by capturing the specific object and among all the pixels of the previous image of the specific object which was captured a certain time ago.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A device for tracing a movement of a mobile robot, comprising:
a camera for capturing a specific object;
a movement tracing and image generating unit for setting a reference area in the present image produced by capturing the specific object by the camera and generating the present image in which the reference area is set;
a difference image extracting unit for extracting a difference image of pixels of the edge of the reference area of the present image and pixels of the reference area of a previous image; and
a microcomputer for tracing a movement of the specific object based on the extracted difference image,
wherein the reference area set in the present image is identical with that of the previous image.

2. The device of claim 1, further comprising:
a storing unit for storing information on the pixels corresponding to the edge of the reference area of the previous image.

3. The device of claim 1, further comprising:
a storing unit for storing information on all the pixels of the previous image.

4. The device of claim 1, wherein the reference area is formed by various shapes and is variable in size.

5. A method for tracing a movement of a mobile robot, comprising:
capturing a specific object;
setting a reference area in the present image produced by capturing the specific object and generating the present image in which the reference area is set;
extracting a difference image of pixels of the edge of the reference area of the generated present image and pixels of the edge of the reference area of a previous image which was captured a certain time ago; and
tracing a movement of the specific object based on the extracted difference image,
wherein the reference area set in the present image is identical with that of the previous image.

6. The method of claim 5, wherein the step of extracting a difference image further comprises:
storing information on the pixels corresponding to the edge of the reference area of the previous image.

7. The method of claim 5, wherein the step of extracting a difference image further comprises:
storing information on all the pixels of the previous image.

8. The method of claim 5, wherein the reference area is formed by various shapes and is variable in size.

9. A method for tracing a movement of a mobile robot, comprising:
capturing a specific object;
comparing pixels corresponding to the edge of a preset reference area among pixels of the present image produced by currently capturing the specific object with pixels corresponding to the edge of the reference area among pixels of a previous image of the specific object which was captured a certain time ago; and
tracing a movement of the specific object on the basis of the result of such comparison.

10. The method of claim 9, wherein the step of comparing the pixels further comprises:
extracting a difference image only of an image corresponding to the reference area of the present image and an image corresponding to the reference area of the previous image.

11. A device for tracing a movement, comprising:
a camera for capturing a specific object;
a movement tracing and image generating unit for setting a reference area in the present image produced by capturing the specific object by the camera and generating the present image in which the reference image is set;
a difference image extracting unit for extracting a difference image of pixels of the edge of the reference area of the present image and pixels of the edge of the reference area of the previous image; and
a microcomputer for tracing a movement of the specific object based on the extracted difference image.

12. The method of claim 11, further comprising:
a storing unit for storing information on the pixels corresponding to the edge of the reference area of the previous image.

13. The method of claim 11, further comprising:
a storing unit for storing information on all the pixels of the previous image.

14. The method of claim 11, wherein the reference area is formed by various shapes and is variable in size.

15. A method for tracing a movement, comprising:
capturing a specific object;
setting a reference area in the present image produced by capturing the specific object and generating the present image in which the reference area is set;
extracting a difference image of pixels of the edge of the reference area of the generated present image and pixels of the edge of the reference area of a previous image which was captured a certain time ago; and
tracing a movement of the specific object based on the extracted difference image.

16. The method of claim 15, wherein the step of extracting the difference image further comprises:
storing information on the pixels corresponding to the edge of the reference area.

17. The method of claim 15, wherein the step of extracting the difference image further comprises:
storing information on all the pixels of the previous image.

18. The method of claim 15, wherein the reference area is formed by various shapes and is variable in size.
